(19) United States
(12) Patent Application Publication
(10) Pub. No.: US 2004/0226231 A1
(43) Pub. Date: Nov. 18, 2004

(54) Blast resistant assemblies

(76) Inventor: Francis C. Dlubak, Freeport, PA (US)

Correspondence Address: Alan G. Towner, Pietragallo, Bosick & Gordon, One Oxford Center, 38th Floor, 301 Grant Street, Pittsburgh, PA, 15219, US

(21) Appl. No.: 10/785,442

(22) Filed: Feb. 23, 2004

Related U.S. Application Data
(60) Provisional application No. 60/450,386, filed on Feb. 27, 2003.

(51) Int. Cl. E06B 3/00

(52) U.S. Cl. 52/204.1; 52/204.5

(57) ABSTRACT

The present invention provides a blast resistant assembly for use as a window, door, or the like, that is capable of withstanding a bomb blast, hurricane, tornado, or other strong force. The assembly includes a composite panel that comprises a glass sheet bonded to a polymeric layer, and a frame that surrounds the composite panel. In the event of an explosion or other strong force, the composite panel is secured within the frame by one or more retainers. Each retainer includes an extension that is embedded within the polymeric layer. The composite panel may also be pivotally mounted to the frame to facilitate deflection of the composite panel during a blast, and to provide a means for emergency exit.

### CROSS-REFERENCE TO RELATED APPLICATIONS

This application claims the benefit of U.S. Provisional Patent Application Serial No. 60/450,386, filed Feb. 27, 2003, which is incorporated herein by reference.

### FIELD OF THE INVENTION

The present invention relates to blast resistant assemblies that are resilient against bomb blasts, hurricanes, tornados and the like, and more particularly relates to blast resistant windows, doors and the like.

### BACKGROUND INFORMATION

U.S. Pat. Nos. 5,960,606 and 6,237,306 to Dlubak disclose penetration resistant windows, which are resistant to hurricane damage. These patents are incorporated herein by reference.

In addition to hurricane-resistant windows, there is a need for bomb blast resistant windows for office buildings and other types of buildings. Such blast resistant windows should minimize damage caused by bomb blasts, e.g., by preventing incursion of the blast force into the building and by reducing damage and injury caused by flying glass and debris. There is also a need for bomb blast resistant doors that serve essentially the same purpose.

The present invention has been developed in view of the foregoing.

### SUMMARY OF THE INVENTION

The present invention provides a blast resistant assembly for use as a window, door, or the like, that is capable of withstanding a bomb blast, hurricane, tornado, or other strong force. The assembly includes a composite panel that consists of at least one glass sheet bonded to at least one polymeric layer, and a frame that surrounds the composite panel. In the event of an explosion or other strong force, the composite panel is secured within the frame by one or more retainers firmly embedded within the polymeric layer of the composite panel. In one embodiment of the invention, the frame includes a hinge arrangement which facilitates deflection of the composite panel during a blast. The composite panel may be removably mounted to the frame, providing an emergency exit following an explosion or similar catastrophic event.

One aspect of the present invention is to provide a blast resistant assembly comprising a frame; a composite panel having at least one glass sheet and at least one polymeric layer mounted in the frame; and at least one retainer extending from the frame and at least partially embedded in the polymeric layer for securing the composite panel within the frame when a force is applied to the composite panel.

Another aspect of the present invention is to provide a retainer for securing a composite panel comprising a glass sheet and a polymeric layer within a frame when a force is applied to the composite panel, wherein the retainer comprises a base structured and arranged for mounting in the frame; and an extension extending from the base and structured and arranged for securing to the polymeric layer.

A further aspect of the present invention is to provide a blast resistant assembly comprising an outer frame; an inner frame pivotally connected to the outer frame; and a composite panel having at least one glass sheet and at least one polymeric layer, wherein the composite panel is mounted in the inner frame.

Another aspect of the present invention is to provide a blast resistant assembly comprising an outer frame; an inner frame pivotally connected to the outer frame; a composite panel having at least one glass sheet and at least one polymeric layer, wherein the composite panel is mounted in the inner frame; and at least one retainer for securing the composite panel within the inner frame when a force is applied to the composite panel, wherein the at least one retainer comprises a base connected to the inner frame and an extension connected to the base and at least partially embedded in the at least one polymeric layer.

These and other aspects of the present invention will be more apparent from the following description.

### BRIEF DESCRIPTION OF THE DRAWINGS

FIG. 1 is an isometric view of a blast resistant assembly in accordance with an embodiment of the present invention.

FIGS. 1a and 1b are plan views of the blast resistant assembly showing alternative embodiments of the retainer.

FIG. 2 is a side sectional view of a retainer and composite panel.

FIGS. 2a, 2b, 2c, 2d, 2e, and 2f are side sectional views of alternative embodiments of the base portion of the retainer.

FIG. 3 is an exploded side sectional view illustrating the construction of a blast resistant assembly in accordance with an embodiment of the present invention.

FIG. 4 is an exploded side sectional view illustrating the construction of a blast resistant assembly in accordance with another embodiment of the present invention.

FIG. 5 is an exploded side sectional view illustrating the construction of a blast resistant assembly in accordance with a further embodiment of the present invention.

FIG. 6 is an exploded side sectional view illustrating the construction of a blast resistant assembly in accordance with another embodiment of the present invention.

FIG. 7 is an isometric view of a blast resistant retainer in including an extension with holes.

FIG. 8 is an isometric view of a blast resistant retainer in accordance with another embodiment of the present invention.

FIGS. 9a-9b are isometric views of a blast resistant retainer in accordance with further embodiments of the present invention.

FIGS. 10a-10c are cross-sectional views of a blast resistant frame and retainer in accordance with an embodiment of the present invention.

FIGS. 11a-11d are cross-sectional views of a blast resistant frame, hinge member, and retainer in accordance with another embodiment of the present invention.

FIG. 12 is an isometric view of the blast resistant frame, hinge member, and retainer shown in FIG. 11d.

FIG. 13 is an isometric view illustrating a blast resistant assembly with release handles in accordance with an embodiment of the present invention.

FIG. 14 is an isometric view of the blast resistant assembly shown in FIG. 13, with the composite panel in an open position.

FIG. 15 is an isometric view of a portion of the blast resistant assembly shown in FIGS. 13 and 14.

FIG. 16 is an isometric view of a portion of the blast resistant assembly shown in FIGS. 13-15.

FIGS. 17-19 are cross-sectional views of a blast resistant assembly in accordance with an embodiment of the present invention.

FIG. 20 illustrates translational forces between a composite panel and frame assembly experienced during a bomb blast in accordance with an embodiment of the present invention.

FIG. 21 illustrates rotational forces between a composite panel and frame assembly experienced during a bomb blast in accordance with another embodiment of the present invention.

FIG. 22 illustrates translational and rotational forces between a composite panel and frame assembly experienced during a bomb blast in accordance with a further embodiment of the present invention.

FIGS. 23-26 are graphs showing pressure traces from a bomb blast test.

FIGS. 27 and 28 are graphs showing additional pressure traces from the bomb blast test.

FIG. 29 is a graph showing a displacement trace from the bomb blast test.

FIG. 30 is a graph showing hinged pressure left.

FIG. 31 is a graph showing hinged pressure right.

FIG. 32 is a graph showing bent dual pane pressure left.

FIG. 33 is a graph showing bent dual pane pressure right.

FIG. 34 is a graph showing bent dual pane deflection.

FIG. 35 is a graph showing bent single pane pressure left.

FIG. 36 is a graph showing bent single pane pressure right.

FIG. 37 is a graph showing bent single pane deflection.

FIG. 38 is a photograph showing a blast resistant assembly following an explosion.

FIG. 39 is a photograph showing a blast resistant assembly being opened for an emergency exit.

FIG. 40 is a photograph showing a blast resistant assembly removed for an emergency exit.

FIG. 41 is a photograph showing an interior view of a blast resistant assembly made from curved, laminated glass following an explosion.

FIG. 42 is a photograph showing an exterior view of a blast resistant assembly made from curved, laminated glass following an explosion.

### DETAILED DESCRIPTION

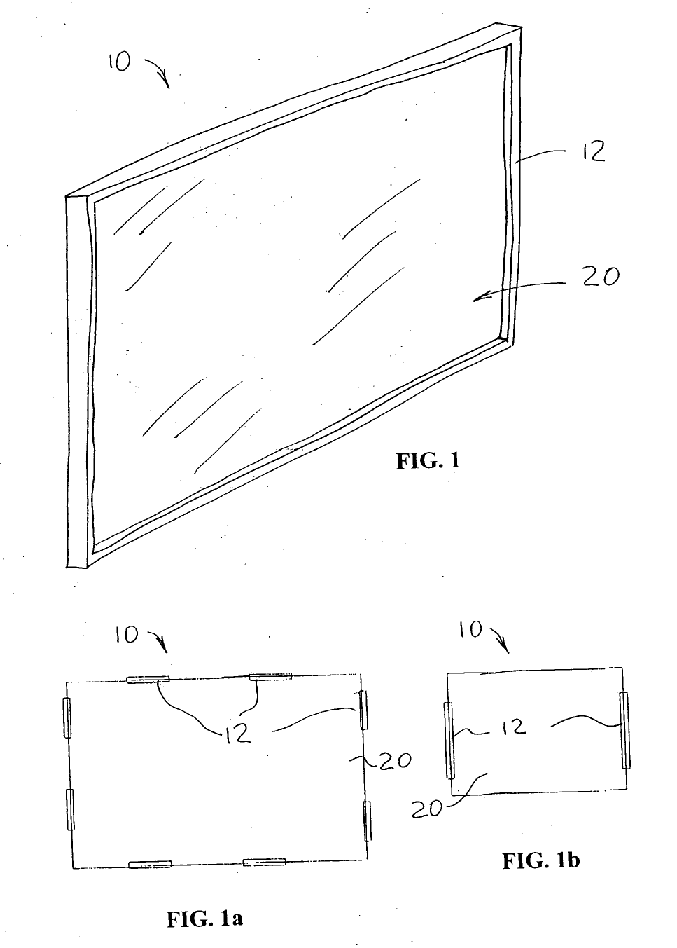

FIG. 1 illustrates a blast resistant assembly 10 in accordance with an embodiment of the present invention. The assembly 10 includes a retainer 12 surrounding a composite panel 20. Although the retainer 12 shown in FIG. 1 continuously surrounds the entire composite panel 20, discontinuous retainer pieces may be used on the sides of the composite panel 20 (as shown in FIG. 1a), and/or the retainer(s) may be used on a limited number of sides of the composite panel 20. For example, a two-sided arrangement as shown in FIG. 1b may be used. The composite panel 20 may be used as a window, door, hinged panel, or the like.

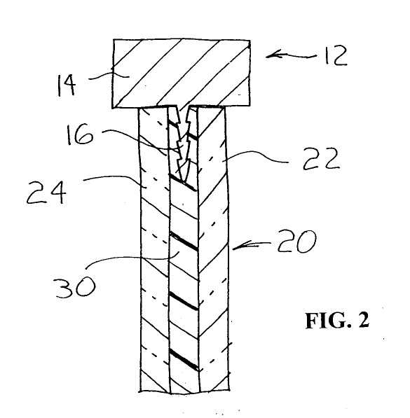

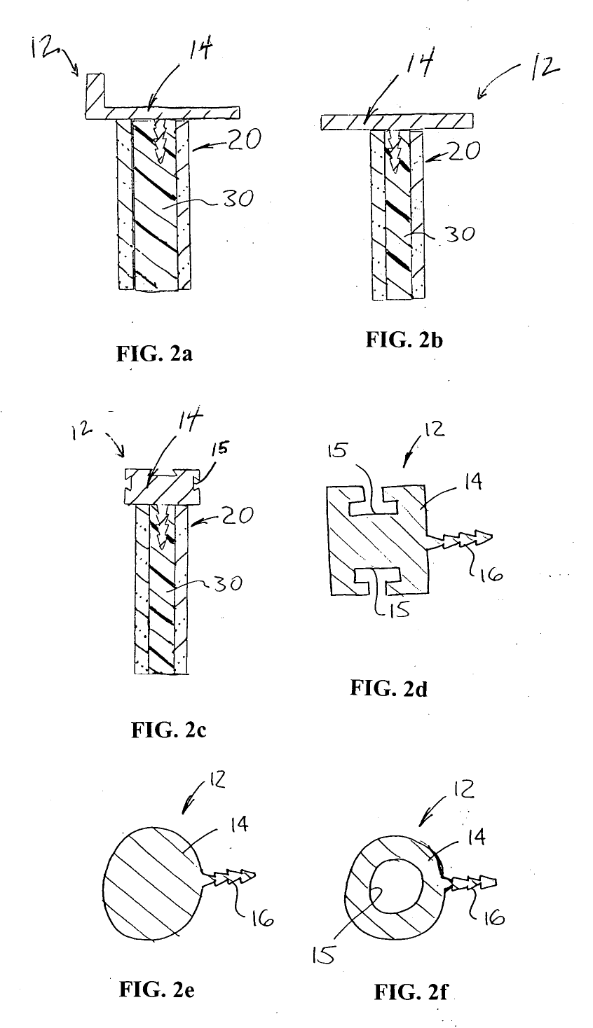

FIG. 2 illustrates a retainer 12 that is embedded within a composite panel 20 in accordance with an embodiment of the present invention. The retainer 12 includes a base 14 and an extension 16, while the composite panel 20 includes glass sheets 22 and 24 separated by a polymeric layer 30. The glass sheets 22 and 24 may have any desired thickness and may comprise any suitable glass such as annealed glass, tempered glass, heat treated glass, iron exchange or low iron glass, ballistic glass, insulated glass, or the like. The polymeric layer 30 may comprise a single layer or multiple layers having a total thickness of from about ⅛ to 2 inch, typically from about ¼ to ½ inch. The polymeric layer 30 may comprise any suitable material such as poly vinyl butyral (PVB), ionoplast, urethane or the like. The polymeric layer 30 may be provided as a solid sheet of material, or may be provided as a liquid material that is injected between the glass sheets 22 and 24 and then cured. Suitable polymeric materials include SentryGlas Plus and Butacite, which are sold by DuPont, and PVB high performance laminate, which is sold by Solutia.

As shown in FIG. 2, the extension 16 of the retainer 12 typically projects into the region between the glass sheets 22 and 24 and is embedded within the polymeric layer 30. The extension 16 may contain surface features which help prevent pulling away of the polymeric layer 30 and glass sheets 22 and 24 from the retainer 12 when a force such as a bomb blast is applied to the composite panel 20. For example, the extension 16 may have a serrated cross-section, e.g. a tree shape, as shown in FIG. 2 with a series of generally triangular projections. In addition, the extension 16 may have any other shape, configuration, or size which adequately resists separation of the composite panel 20 from the retainer 12. For example, the extension 16 may comprise a first portion extending from the base and a second portion extending from the first portion in a direction substantially perpendicular to the first portion. The first and second portions may form an L shape or T shape. The extension 16 may also have a triangular shape, round shape, or barbed shape. Furthermore, although the embodiments shown in the figures include a single extension 16 embedded in the polymeric layer 30, multiple extensions may be used.

The base 14 of the retainer 12 is fixedly attached to the extension 16, and serves to secure the retainer 12 to a frame, as more fully described below. When a force such as a bomb blast is applied to the composite panel 20, the base 14 secures the retainer 12 within the frame, thereby securing the composite panel 20 within the frame. The base 14 may have any suitable shape, size, or design. For example, the base 14 may have a generally rectangular, square, trapezoidal, triangular, or round cross-section. FIG. 2a depicts a base 14 with an L-shaped base design, while FIG. 2b depicts a base 14 with an elongated rectangular design. FIG. 2c depicts a generally rectangular base portion 14 with trapezoidal shaped channels or grooves 15. FIG. 2d depicts a generally square base 14 with T-shaped channels or grooves 15. FIG. 2e depicts a base 14 with a generally round shape, while FIG. 2f shows the same round base with a central, longitudinal hole 15. While the hole 15 is depicted in FIG. 2f as having a generally round cross-section, the hole 15 may have any suitable shape or size.

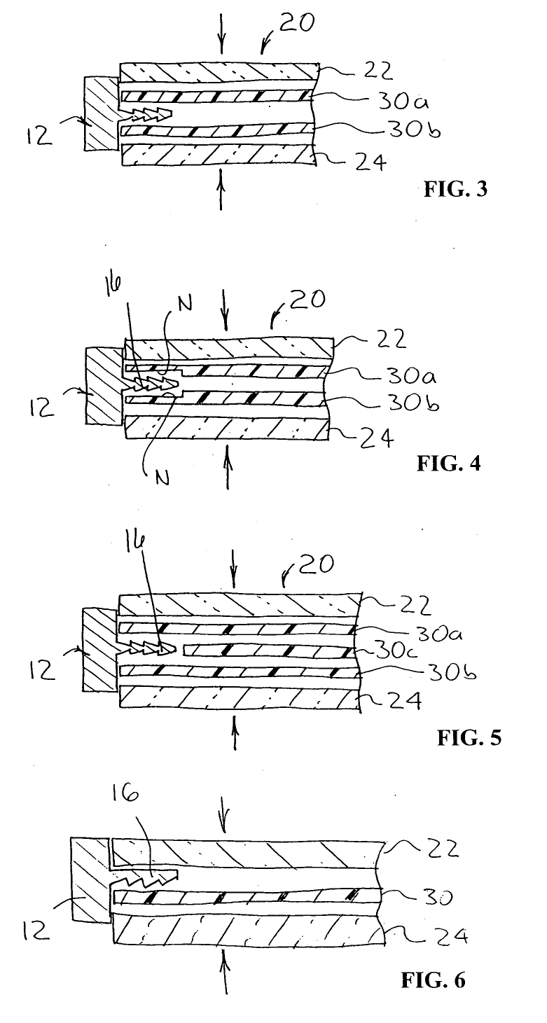

FIG. 3 illustrates the construction of a composite panel 20 and embedded retainer 12 in accordance with an embodiment of the present invention. As shown, the retainer 12 is inserted between two separate polymeric sheets 30a and 30b. Two glass sheets 22 and 24 are pressed against the polymeric sheets 30a and 30b, typically under heat and pressure, in order to form the assembly shown in FIG. 2. Suitable temperatures, pressures and times may be determined by routine experimentation.

FIG. 4 illustrates the construction of a composite panel 20 and embedded retainer 12 similar to that shown in FIG. 3. In FIG. 4, however, the polymeric sheets 30a and 30b have peripheral notches N in the regions near the extension 16 of the retainer 12. These notches N help to embed the extension 16 within the composite panel 20.

FIG. 5 illustrates the construction of a composite panel 20 and embedded retainer 12 that uses three sheets of polymeric material 30a, 30b and 30c. The outer polymeric sheets 30a and 30b have edges that are substantially coextensive with the edges of the glass sheets 22 and 24. However, the inner polymeric sheet 30c has a recessed outer edge, which only extends near the tip of the extension 16 of the retainer 12.

FIG. 6 illustrates the construction of a composite panel 20 and embedded retainer 12 wherein only one side of the extension 16 contains surface features that prevent pulling away from the polymeric layer 30. In a particular embodiment, the extension 16 has two opposing faces and each of the opposed faces contacts the polymeric layer. In another embodiment, only one of the opposing faces contacts the polymeric layer.

In addition to having a flat surface, the composite panel may have a curved, arched or bent surface, which may allow the window or door to withstand higher loads. When a force is applied against a curved composite panel, the glass will typically dissipate the energy more slowly, resulting in a different glass shard size and pattern, reduced deflection, and decreased glazing velocity.

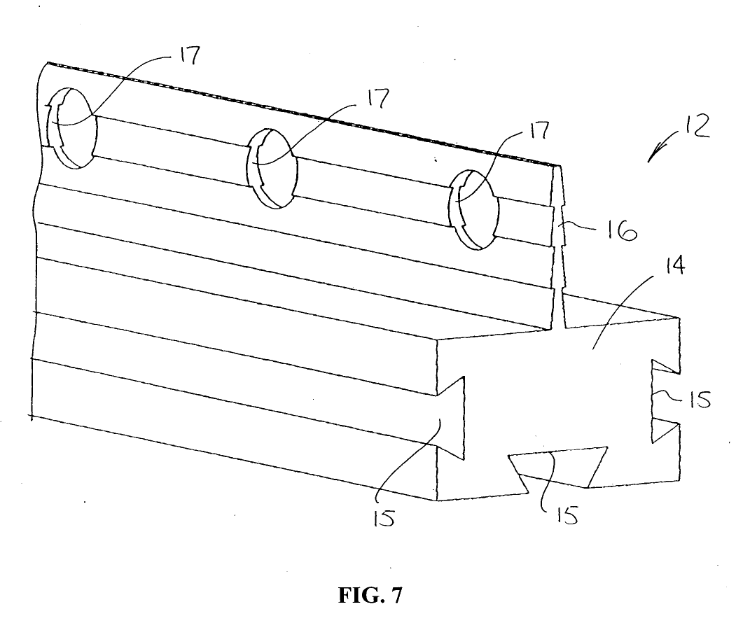

FIG. 7 illustrates a particular embodiment of the retainer 12. As shown, the base 14 of the retainer 12 may include longitudinal channels or grooves 15, which help secure the retainer 12 within a frame (not shown), as more fully described below. The extension 16 of the retainer 12 may include holes 17, which further help to secure the extension 16 within the polymeric layer 30. The holes 17 may be partially or fully filled by the polymeric material during assembly of the window or door. In this manner, the extension 16 may be more firmly embedded in the polymeric layer 30. Although circular holes 17 are shown in the embodiment of FIG. 7, numerous alternative shapes, sizes, and spacings may be used. Furthermore, such holes 17 may extend partially or entirely through the thickness of the extension 16. The retainer 12 may be made from any suitable material such as metal or high strength plastic. In a preferred embodiment, the retainer 12 is made from extruded aluminum.

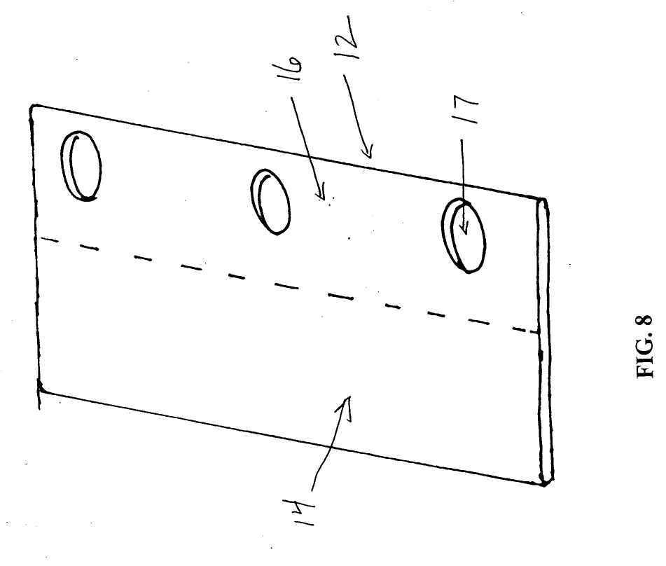

FIG. 8 illustrates another embodiment of the retainer 12 in which the extension 16 has substantially planar opposing faces, and forms a flat plate with base portion 14. The extension 16 may optionally include holes 17 for securing the retainer 12 within the polymeric layer 30. The holes 17 may be partially or fully filled by the polymeric material during assembly of a window or door. Furthermore, the extension 16 may be rigidly attached to a base portion 14 that doubles as a window or door frame. The retainer 12 may be manufactured from plastic, aluminum, steel, fabric, or any other suitable material.

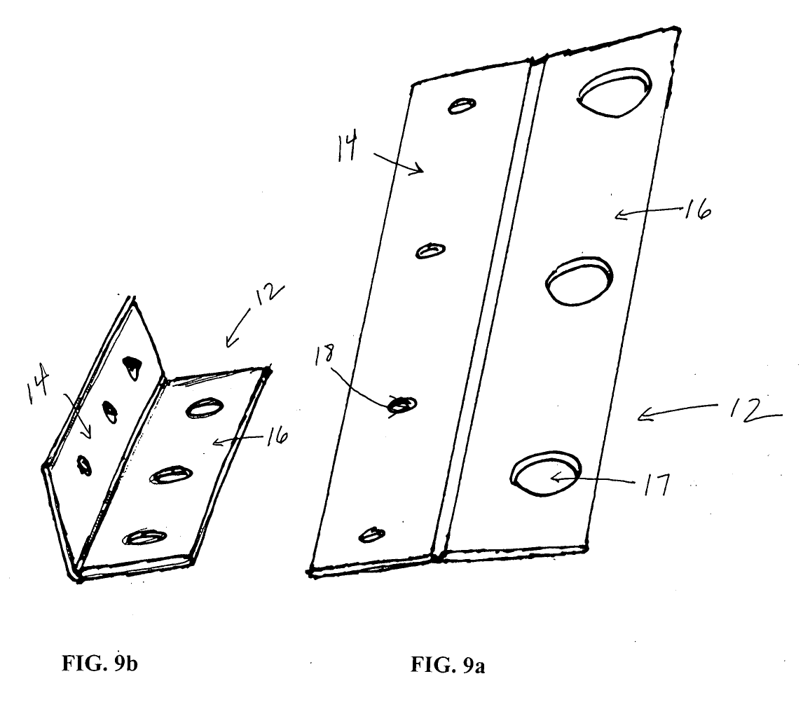

FIG. 9a illustrates another embodiment of the retainer 12 in which the extension 16 is hingedly or rotatably attached to a base portion 14. The base portion 14 may double as a window or door frame. The base portion 14 may be attached to a wall using mounting holes 18. The extension includes optional holes 17 for securing within the polymeric layer 30. FIG. 9b depicts the same retainer 12 with the extension 16 rotated approximately 90 degrees with respect to the base portion 14.

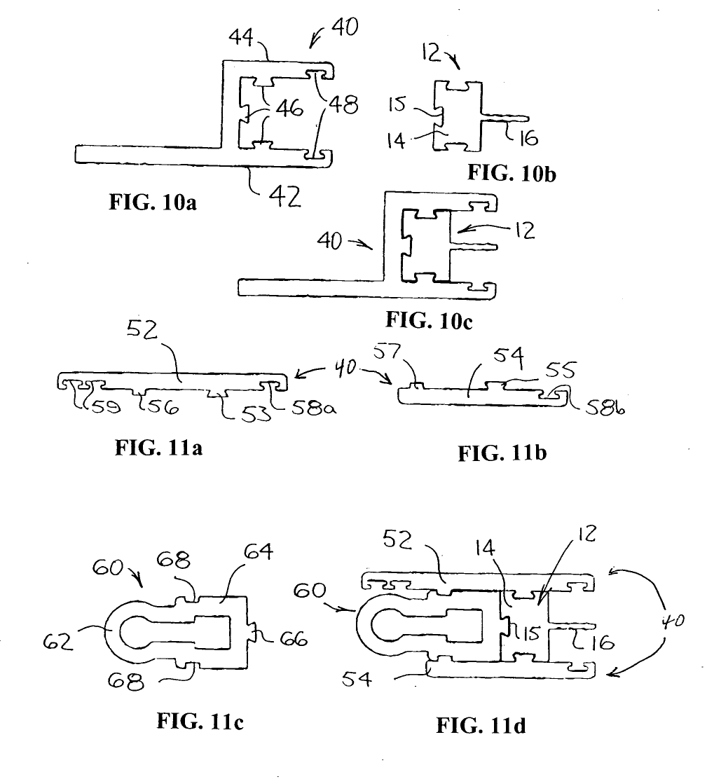

FIGS. 10a-10c illustrate a frame 40 and retainer 12 in accordance with an embodiment of the present invention. The frame 40 includes an exterior face 42 and an interior face 44. Projections 46 inside the frame 40 fit within the channels 15 of the retainer 12. Thus, as shown in FIG. 10c, the retainer 12 is slidably engaged in channels of the frame 40. The frame 40 also includes channels or grooves 48 which are capable of receiving weather stripping, caulking or the like (not shown) which help seal the frame 40 to the composite panel (not shown) when the window or door is assembled.

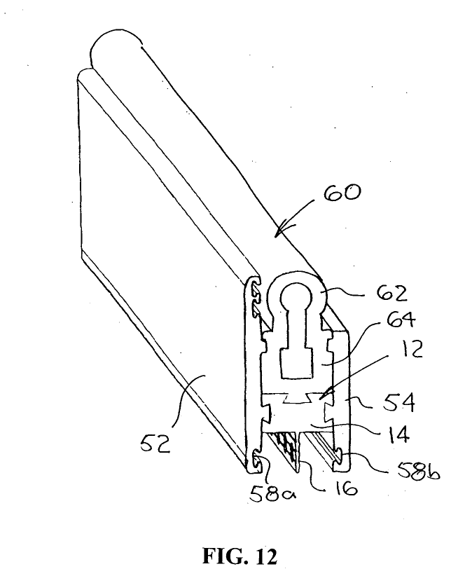

FIGS. 11a-11d illustrate a frame 40, hinge member 60, and retainer 12 in accordance with another embodiment of the present invention. The frame 40 includes an outer section 52 and an inner section 54. The outer section 52 includes projections 53 and 56, and recesses 58a and 59. The inner section 54 includes projections 55 and 57, and recess 58b. As shown in FIG. 11c, a hinge member 60 is provided to rotatably attach the frame 40 within a wall, window, or door opening (not shown). The hinge member 60 has a generally cylindrical outer end 62 and a generally square inner end 64. A projection 66 extends from the square inner end 64. Channels 68 are provided along the sides of the hinge member 60. As shown in FIG. 11d, the hinge member 60 is mounted between the outer and inner frame sections 52 and 54, with the projections 56 and 57 fitting inside the side recesses 68 of the hinge member 60. As also shown in FIG. 11d, the retainer 12 is mounted between the outer and inner frame sections 52 and 54, with the projections 53 and 55 secured in the channels 15 of the retainer 12. The projection 66 of the hinge member 60 is secured in the bottom channel 15 of the retainer 12. Recesses 58a, 58b and 59 may be fitted with weather stripping (not shown) or the like. An isometric view of the blast resistant frame of FIG. 11d is shown in FIG. 12.

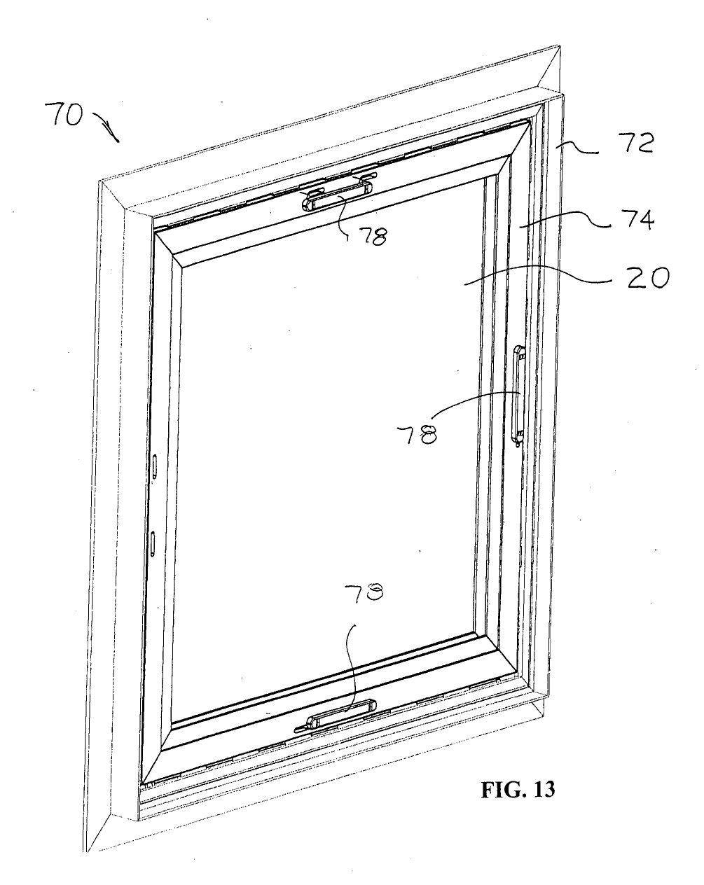

FIG. 13 illustrates a preferred embodiment of the blast resistant assembly 70. The assembly 70 includes an outer frame 72 which may be mounted in a building by any suitable means. The outer frame 72 is structured and arranged to receive the inner frame 74, thereby securing the inner frame 74 within the outer frame 72. The inner frame 74 is pivotally connected to the outer frame 72, meaning the inner frame 74 can pivot and absorb shock, while still remaining secured to the outer frame 72, when a blast or similar strong force occurs, and the inner frame 74 can also be unhinged and pivoted away from the outer frame 72 to provide an emergency exit. Release handles 78 are mounted on the interior side of the assembly 70 for installation and removal of the inner frame 74 with respect to the outer frame 72.

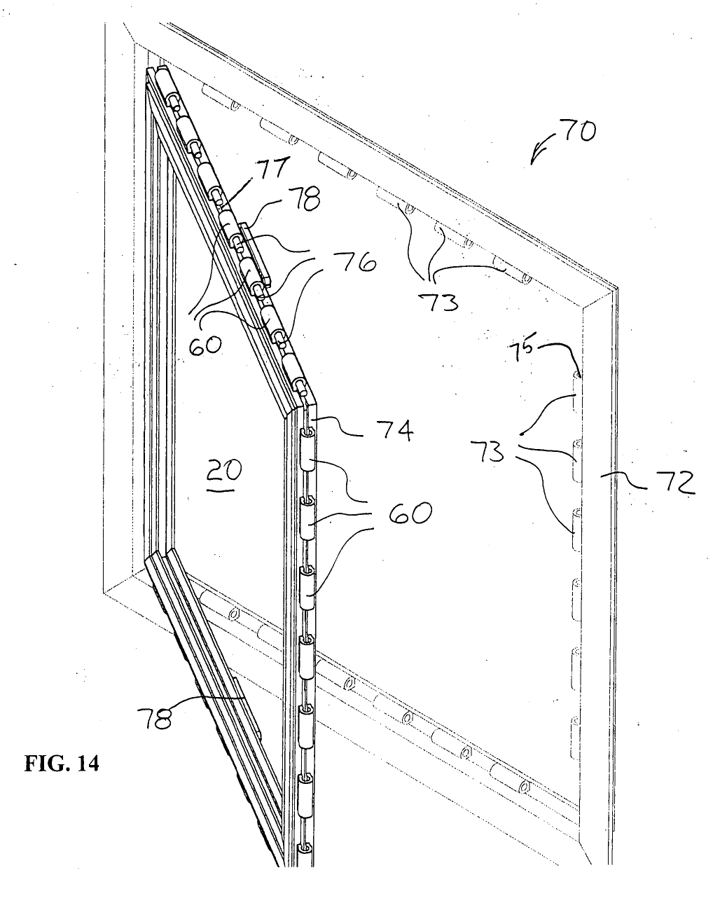

FIG. 14 shows the blast resistant assembly 70 with the inner frame 74 pivoted to an open position in relation to the outer frame 72. Multiple hinge members 60 are positioned around the periphery of the inner frame 74. Pins 76 are retractably mounted within the hinge members 60. The pins 76 are slidable between retracted and extended positions. The outer frame 72 includes hinge projections 73 which contain longitudinal holes 75 sized to receive the pins 76. The hinge projections 73 are axially aligned with the hinge members 60 and pins 76 when the inner frame 74 is moved to a closed position in the outer frame 72. To secure the inner frame 74 in the outer frame 72, the pins 76 are moved from a retracted position to an extended position, engaging them within the holes 75 of the hinge projections 73. To open the inner frame 74, the pins 76 are moved back to a retracted position, disengaging them from the holes 75 of the hinge projections 73. Although FIG. 14 shows a hinge mounting system on all four sides of the frames 72 and 74, other configurations are possible. For example, the hinge connectors may only be provided on one, two or three sides of the frames. In addition, the pins 76 may be mounted on a movable bar 77, and one or more handles 78 may be connected to the bar 77 to manually slide the pins 76.

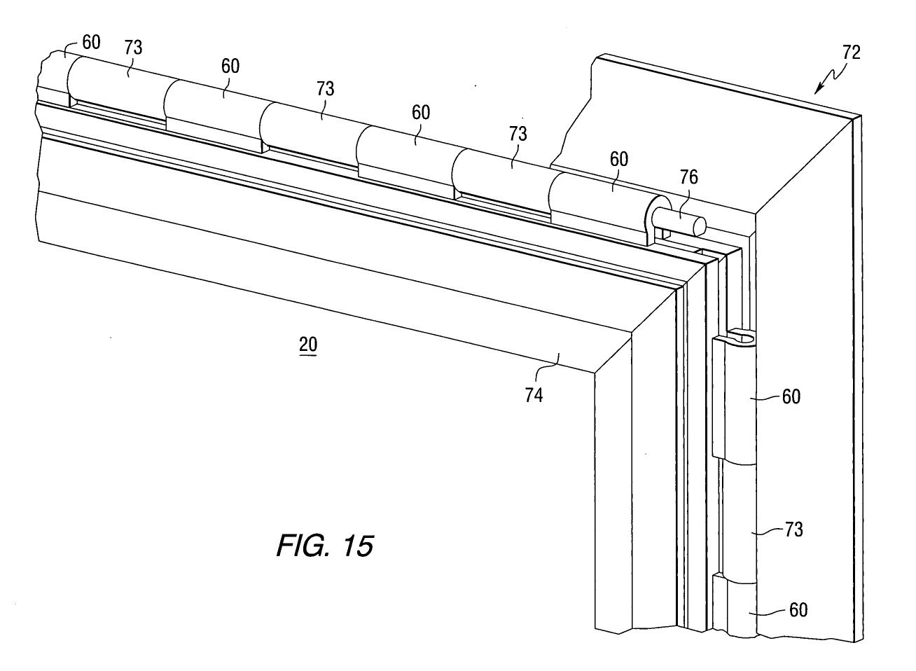

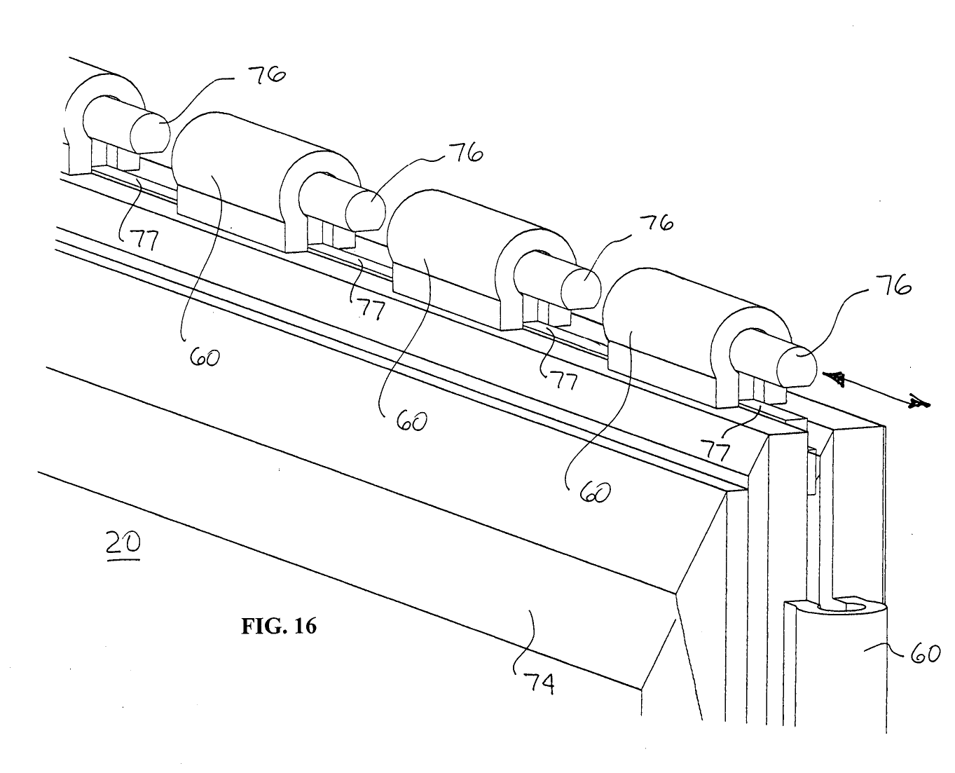

FIG. 15 illustrates a portion of the outer and inner frames 72 and 74 in the closed position. As shown in FIG. 15, the hinge members 60 of the inner frame 74 are axially aligned with the hinge projections 73 of the outer frame 72. In the closed position, the hinge members 60 and hinge projections 73 are secured together through extension of the pins 76 from the hinge members 60 into the hinge projections 73.

FIG. 16 illustrates extension and retraction of the pins 76 with respect to the hinge members 60. As shown in FIG. 16, the pins 76 are mounted on a bar 77 which slides within a groove in the inner frame 74. Sliding movement of the bar 77 causes the pins 76 to extend or retract. The bar 77 may be moved by manual means, such as handles (not shown). Alternatively, the bar 77 may be moved by any other suitable means such as an electronic actuator. Thus, the blast resistant assembly may be fitted with a hinge mounting system to provide a means for emergency exit after a bomb blast has occurred.

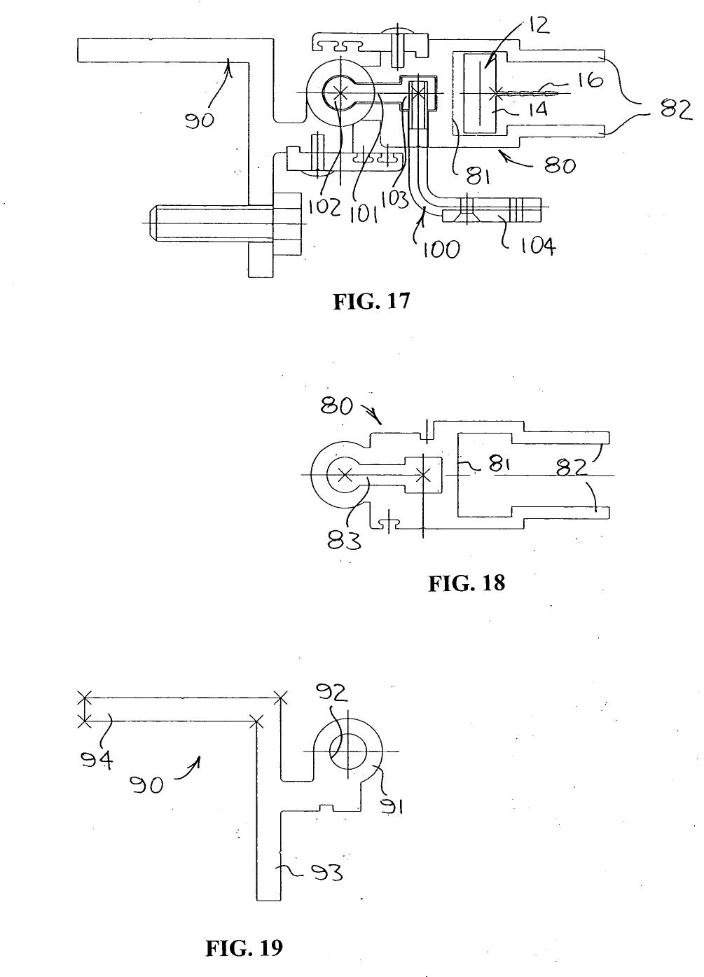

FIGS. 17-19 illustrate a blast resistant assembly in accordance with another embodiment of the present invention. In this embodiment, an inner frame 80 includes a channel 81 within which the retainer 12 is mounted. The channel 81 may be sized larger than the cross-sectional area of the retainer 12, allowing the retainer 12 to move slightly leftward and/or slightly rightward in relation to the inner frame 80. Thus, the retainer 12 and attached composite panel (not shown) are capable of limited translational movement within the channel 81, and the retainer 12 is considered slidably mounted in the inner frame 80. As shown in FIGS. 17 and 18, the inner frame 80 may include interior and exterior projections 82 which hide the extension 16 of the retainer 12 from view in the installed assembly, and which may also help secure the composite panel 20 in the inner frame 80.

The inner frame 80 may also include a hinge member 83, similar to the hinge members 60 shown in FIGS. 11-16. As shown in FIG. 19, the outer frame 90 may include a hinge projection 91 with a hole 92 there through (similar to the hinge projections 73 shown in FIGS. 17 and 18). The outer frame 90 may include an interior leg 93 and an exterior leg 94. As shown in FIG. 17, the hinge member 83 of the inner frame 80 may be pivotally mounted on the hinge projection 91 of the outer frame 90. An actuator 100 includes an arm 101 connecting a pin 102 to a bar 103. A handle 104 may be connected to the bar 103. Movement of the handle 104 causes the arm 101, pin 102 and bar 103 to slide with respect to the hinge member 83 of the inner frame 80, in a manner similar to that shown in FIG. 16. Thus, when the pin 102 is extended, the inner frame 80 and outer frame 90 are secured together, but may be rotated with respect to each other upon the force of a bomb blast or the like against the composite panel and inner frame 80.

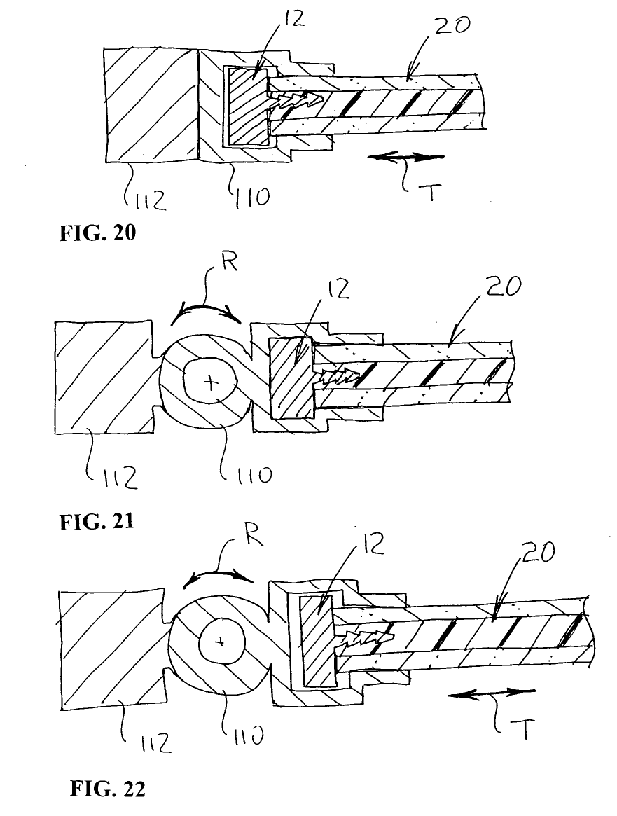

FIG. 20 illustrates a blast resistant assembly, which undergoes translational movement when subjected to a bomb blast or the like. In the embodiment shown in FIG. 20, the retainer 12 and composite panel 20 undergo sliding or translational movement T when subjected to a blast as a result of linear movement of the retainer 12 within the inner frame 110. The inner frame 110 has a channel or groove for receiving the retainer 12, and the channel is sized slightly larger than the retainer 12, allowing for this translational or sliding movement. In this embodiment, the inner frame 110 is fixedly secured to the outer frame 112, which, in turn, is fixedly secured to a building or wall.

FIG. 21 illustrates a blast resistant assembly in which the inner frame 110 and outer frame 112 are mounted for rotational movement with respect to each other. In this embodiment, when the composite panel 20 is subjected to a bomb blast or the like, the composite panel 20, retainer 12 and inner frame 110 are able to rotate together as a unit in relation to the outer frame 112. For example, if a blast occurs outside the window or door, the resultant inward force on the composite panel 20 will cause the window or door to bow inward thereby causing the inner frame 110 to rotate inward with respect to the outer frame 112.

The embodiment shown in FIG. 22 is a combination of the embodiments shown in FIGS. 20 and 21. In the embodiment of FIG. 22, the composite panel 20 and retainer 12 undergo sliding or translational movement T with respect to the inner frame 110. In addition, the inner frame 110 undergoes rotational movement R with respect to the outer frame 112. In this embodiment, energy from a bomb blast or the like may be absorbed by both the translational movement T and rotational movement R of the assembly.

The blast resistant assemblies described herein may be installed on a building or similar structure as OEM equipment, or may be retrofitted to replace existing windows, doors, or the like.

The following examples are intended to illustrate various aspects of the present invention, and are not intended to limit the scope of the invention.

### EXAMPLE 1

A bomb blast test was conducted as follows on a window assembly similar to that shown in FIG. 17. Two window systems were subjected to a 283-pound ammonium nitrate and fuel oil (ANFO) charge located 120 feet from the windows. The window and casing assembly was mounted in a concrete non-responding wall with clearing wings to simulate a semi-infinite target space. This was done in order to get a fully developed reflected shock wave off the structure, thus representing the maximum overpressure the test article would experience. The objective of the test was to determine the suitability of the concept window/casing assembly for mitigation of effects from a blast event.

The bomb blast-resistant window was mounted in a concrete slab, fitted on each end with clearing walls. The concrete slab (called hereafter the non-responding wall) was designed such that it would not fail during the test. Note that the clearing walls and support structure provided enough room on the sides and top of the window to allow a fully developed reflected shock wave, simulating windows in a large building. A single test was conducted, with the test article mounted in the non-responding wall. Pressure traces (both reflected and incident pressure) were recorded, as well as the center displacement of the wall itself. The results of the test, as well as any data reduction techniques used, are presented later.

The test wall was constructed with openings that were sized to fit the test specimens. One-quarter inch steel plates were welded all around the cutouts. Lengths of 2″×2″×¼″ tubing were welded to provide a bracket upon which the window could be mounted. Three-eighths inch diameter bolts spaced on eight-inch centers were used to mount the test article to the tubing.

The explosive charge was placed at a standoff distance of 120 ft, with the center of the charge located at 30-inches above ground level. The charge was initiated with tandem Reynolds RP-81 detonators contained within a one-half pound C-4 charge.

Instrumentation for the test consisted of piezoelectric pressure gauges for measuring incident and reflected pressure, and a linear displacement gauge to measure wall deflection. The wall deflection is not strictly applicable to the analysis of the test articles, but the results are included nonetheless. Three pressure gauges were mounted on the front surface of the wall to measure reflected pressure. One gauge measured free field incident pressure. In addition, gauges were mounted on the back wall (reflected pressure) and the ceiling (incident pressure) inside the reaction structure itself. Since the window did not shatter, these two inside gauges did not record any significant overpressure.

The data was recorded on National Instruments VXI™ system recording 16-bit digital signals at 200 kHz. A backup PXI system recorded 12-bit, 125 kHz data. Pressure measurements were made using PCB™ piezoelectric transducers and a corresponding PCB™ 855 gauge power amplifier. This amp managed both the incident and reflected pressure measurements for the experiment.

The incident pressure gauge was placed at the same height as the center of the charge. The other incident gauge was placed on the ceiling inside the reaction structure. The reflected pressure gauges were mounted to the wall panel using threaded plastic inserts. To prevent thermal biasing, the active surface of the gauge was coated with RTV silicone. The fourth reflected pressure gauge was mounted to the back wall inside the reaction structure.

Global wall deflection was measured using a linear displacement transducer. This simply recorded the position of the wall during the blast event. Again, it is not strictly applicable to the analysis of the test article, but is included to assist in measuring the total impulse imparted to the test wall.

The primary data reduction technique used on the pressure gauges was a curve-fit of the release portion of the wave. A modified Friedlander fit of the release portion was used to determine a peak pressure without interference from transducer noise or from a von Newman type spike. The von Newman spike is ignored because it is not accounted for in the modified Friedlander pressure traces used by the pre-test calculations conducted with the standard computer code.

In addition to curve fitting, many of the pressure traces were offset and needed a baseline adjustment. When this occurred, the baseline was shifted so that the pressure just prior to the initial spike averaged zero. After they were shifted to zero before the shock, the pressure traces were also integrated to yield positive impulse data.

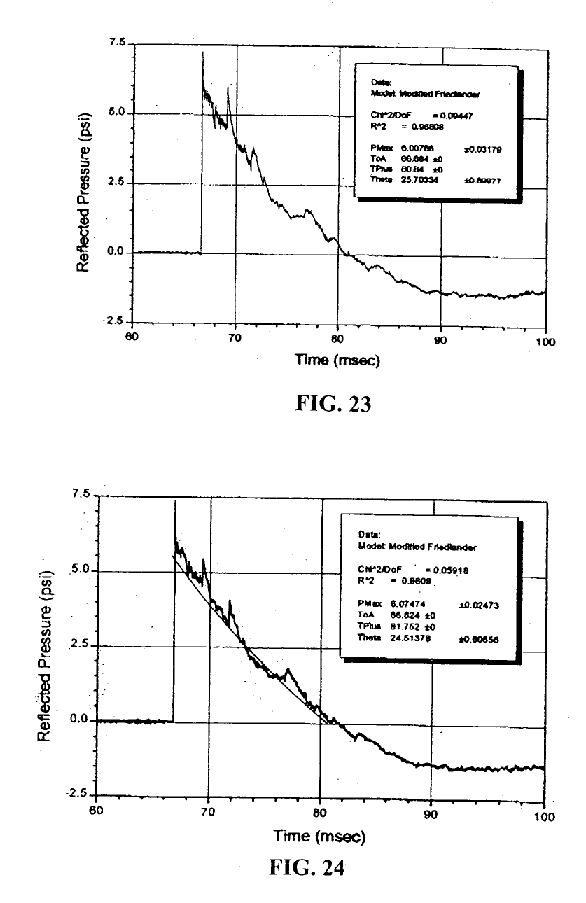

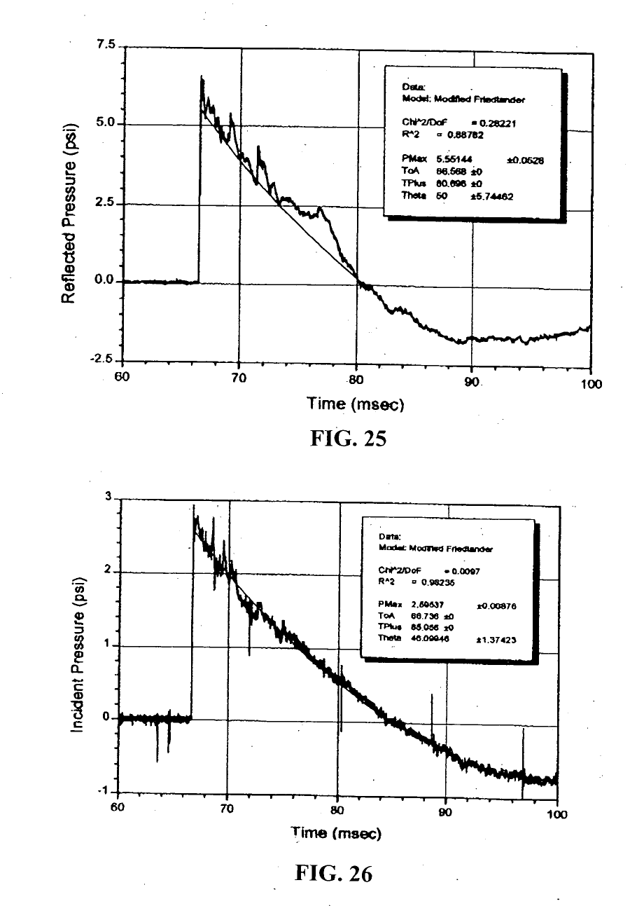

FIGS. 23-26 show the pressure traces of the three front reflected pressure gauges and the free field gauge, respectively, along with the modified Friedlander fit.

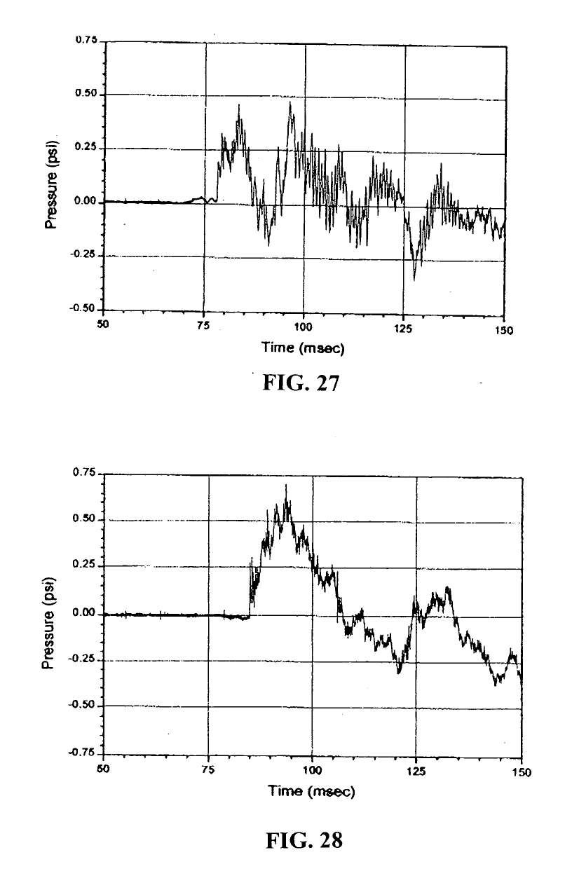

FIGS. 27 and 28 show the pressure traces for the gauges mounted inside the reaction structure. FIG. 27 is the pressure trace from the ceiling-mounted incident pressure gauge. FIG. 28 is the pressure trace from the back-wall-mounted reflected pressure gauge.

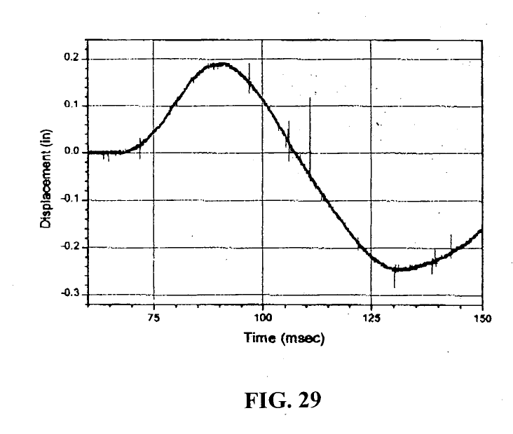

FIG. 29 shows the midspan deflection of the non-responding wall.

Table 1 summarizes the pressure data for the four gages, along with the data for the free-field pencil gauge.

TABLE 1
Pressure data for gauges experiencing shock loading

| | Max | Time of | Positive | Positive |
|---|---|---|---|---|
| | Pressure | Arrival | Duration | Impulse |
| Channel Description | (psi) | (msec) | (msec) | (psi-msec) |
| South Reflected Gauge | 6.01 | 66.7 | 14.2 | 36.06 |
| Center Reflected Gauge | 5.55 | 66.6 | 14.1 | 41.56 |
| North Reflected Gauge | 6.07 | 66.8 | 14.9 | 37.40 |
| Pencil Gauge (Incident) | 2.59 | 66.7 | 18.3 | 21.09 |

From Table 1, it can be seen that the average measured maximum reflected pressure was 5.87 psi, and that the average total positive impulse was 38.34 psi-msec. Peak pressure was taken from a modified Friedlander fit of the pressure trace, to avoid overly high pressure readings resulting as artifacts of the instrumentation. Impulse was found by integration of the raw pressure data.

### EXAMPLE 2

Blast resistant window assemblies similar to the assembly shown in FIG. 22 were tested as follows:

Window 1: 50″×68″ area window with glass construction 3/16″ glass, 270 mil PVB sold under the designation Butacite by DuPont, 3/16″ glass, ¾″ edge bite. The framing system was tested at 15.3 psi peak impulse with a load of 101 psi-ms. The glass construction broke with the majority of the glass remaining in the frame with limited spall. Gradual pullout was observed on the sides of the window with significant deflection of glass.

Window 2: 50″×68″ area window with glass construction 3/16″ glass, 270 mil ionoplast sold under the designation SentryGlas by DuPont, 3/16″ glass, ¾″ edge bite. The framing system was tested at 15.6 psi peak impulse with a load of 112 psi-ms. Slight pullout was observed with low deflection resulting in little to no spall and the majority of the glass remaining in the frame.

### EXAMPLE 3

A bomb blast test was conducted on a window assembly similar to that shown in FIG. 12. The test included two buildings with four windows each, for a total of eight windows tested. Each window consisted of two panes of laminated glass with the extension of a retainer bonded in between the glass within the laminate. The following laminates were tested: anchored PVB, clamped PVB, bolted ionoplast, and bolted polycarbonate. The extension of the retainer consisted of extruded aluminum. Each window was sized 4 feet wide by 6 feet high and was subjected to an explosion from a truck bomb located 75 feet away.

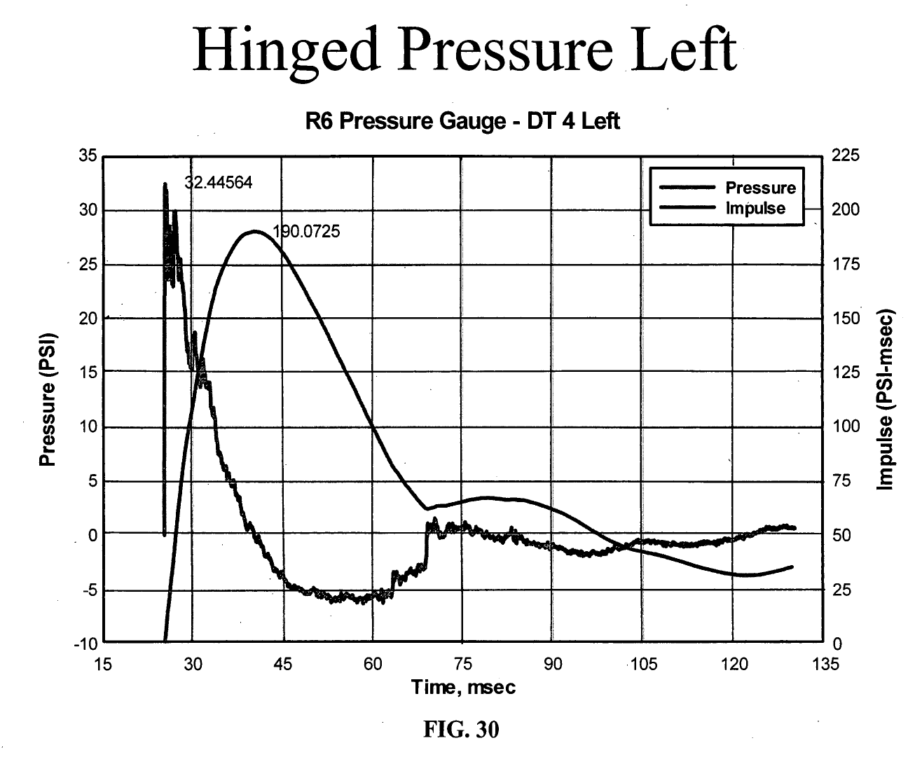

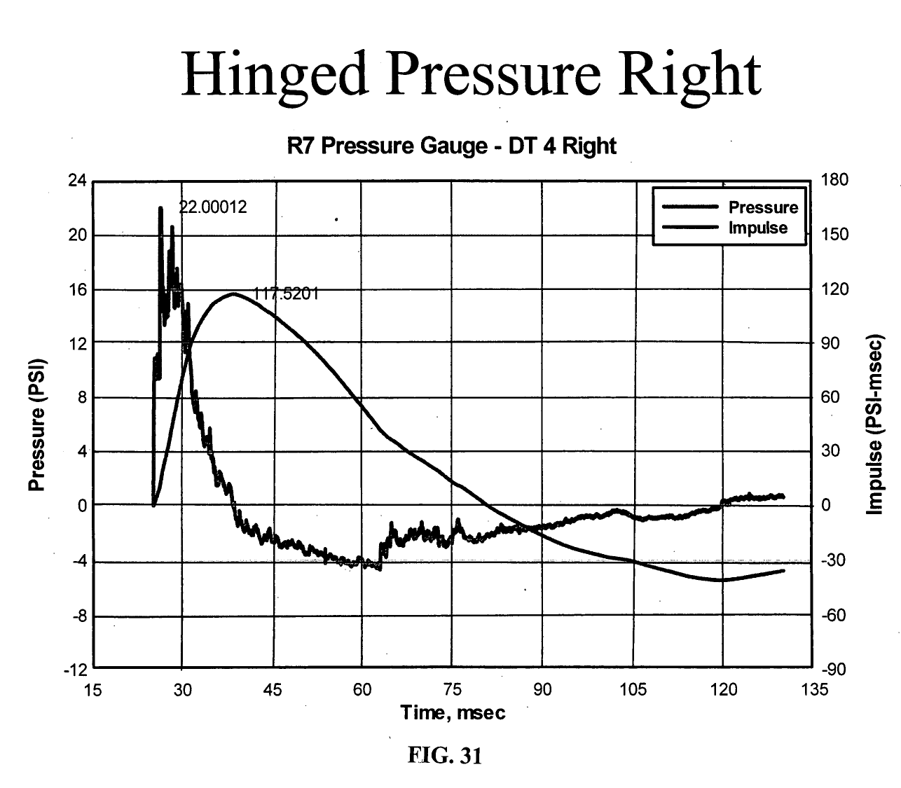

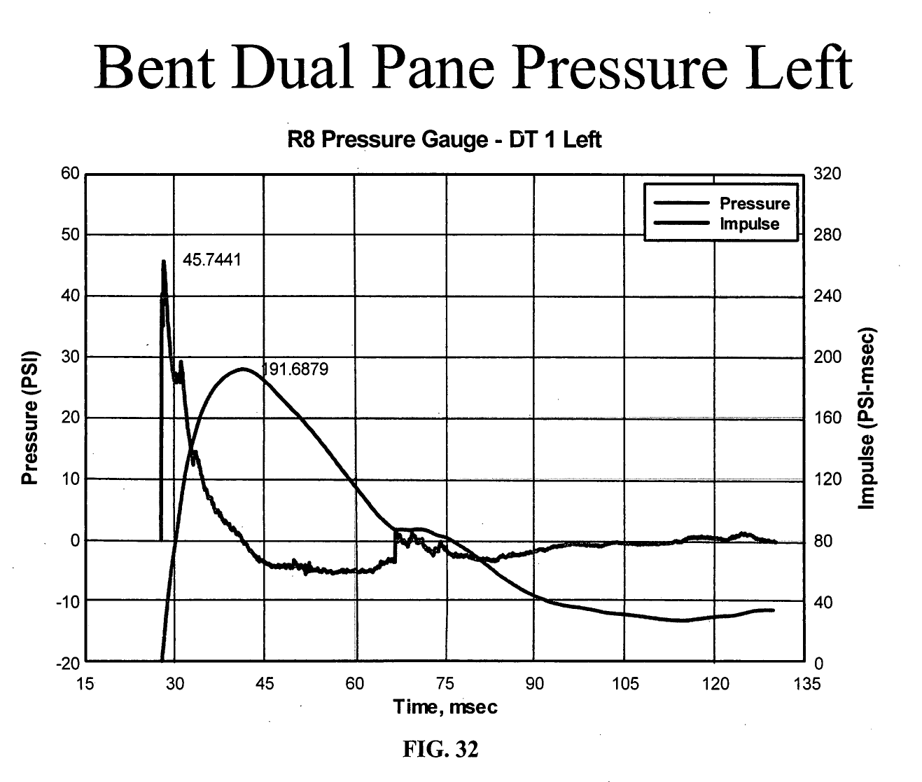

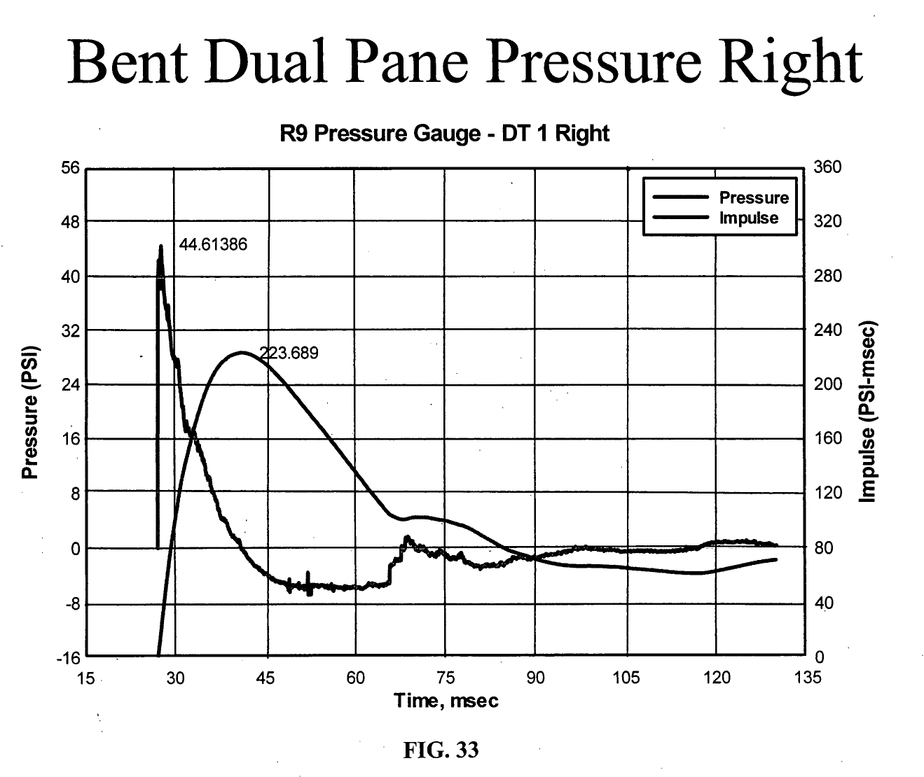

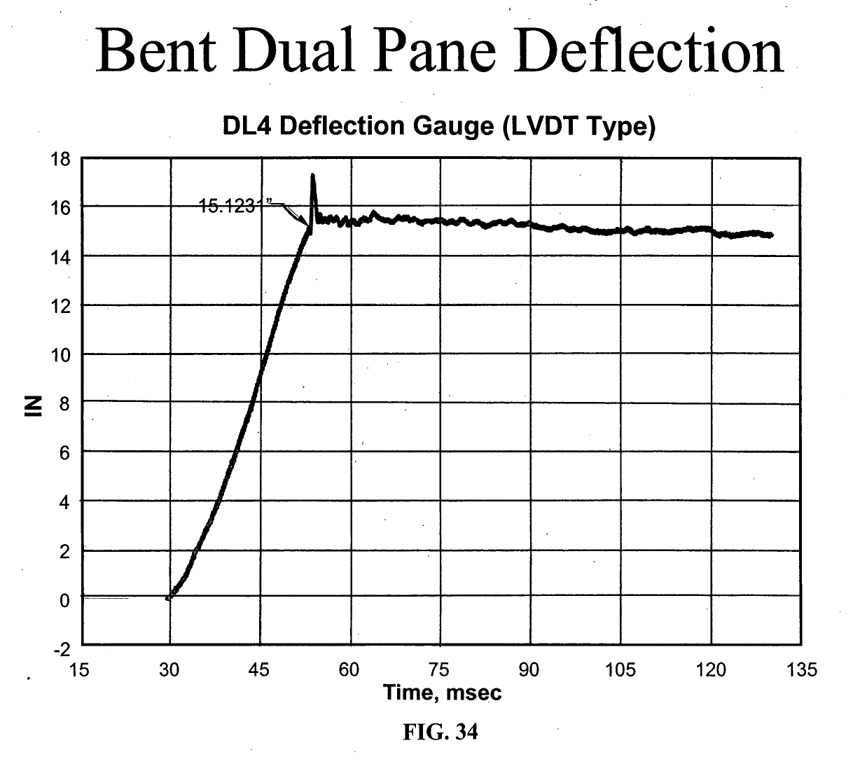

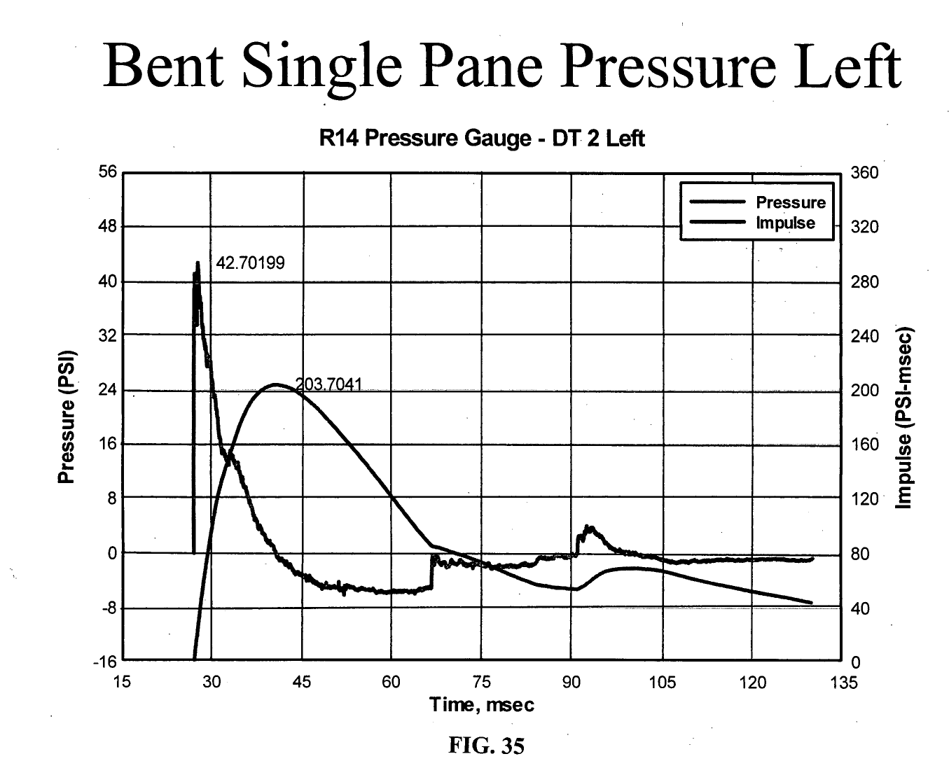

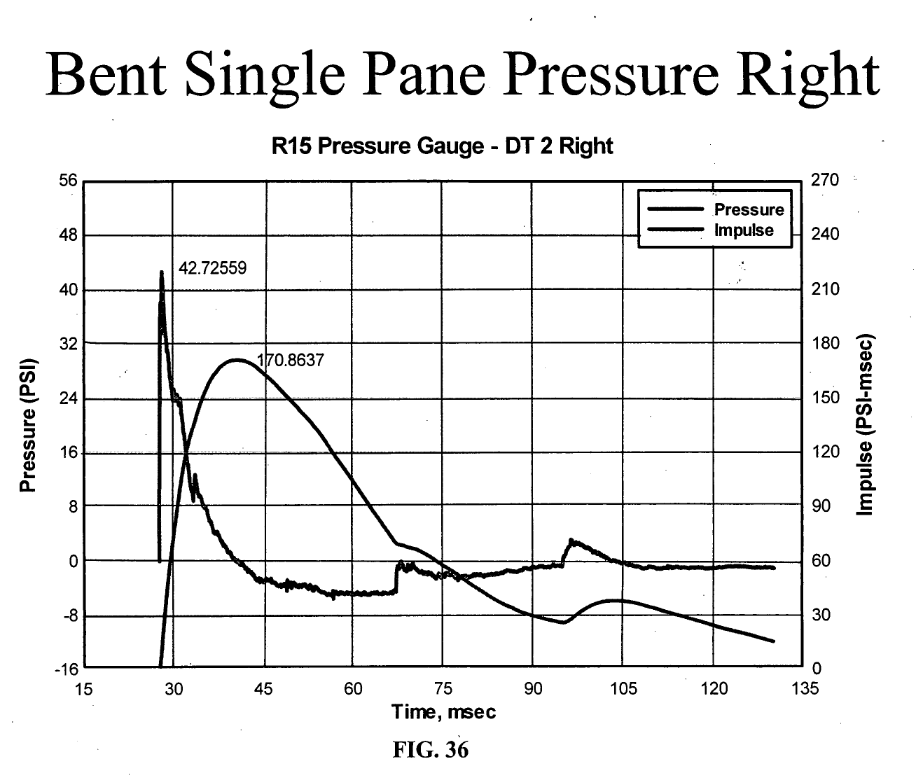

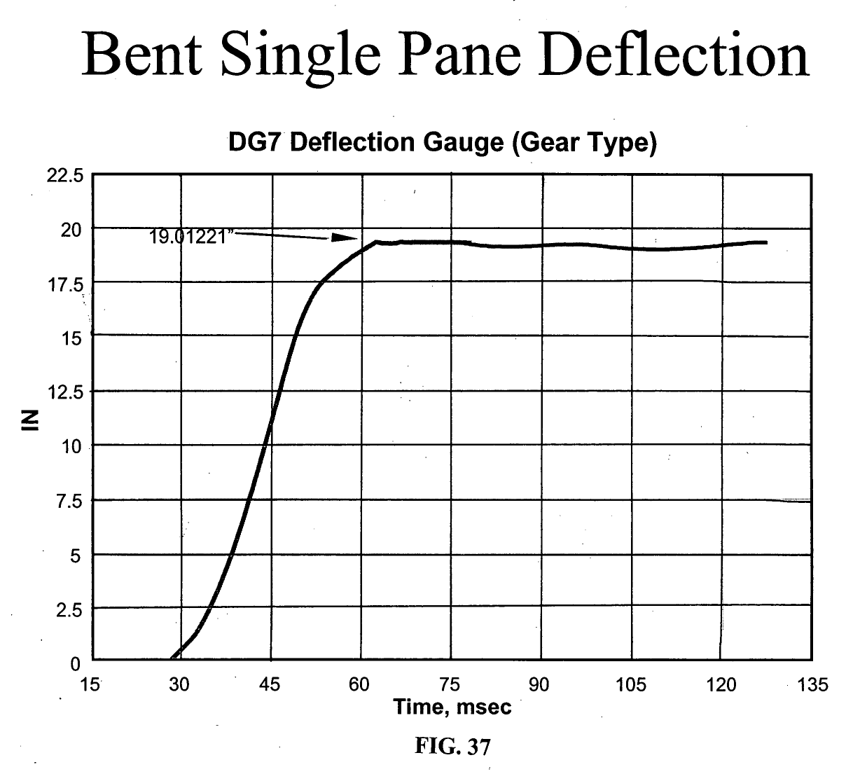

FIGS. 30-37 present the test results. FIGS. 30 and 31 depict hinged pressure left and right, respectively. FIGS. 32 and 33 depict bent dual pane pressure left and right, respectively. FIGS. 34 depicts bent dual pane deflection. FIGS. 35 and 36 depict bent single pane pressure left and right, respectively. FIG. 37 depicts bent single pane deflection.

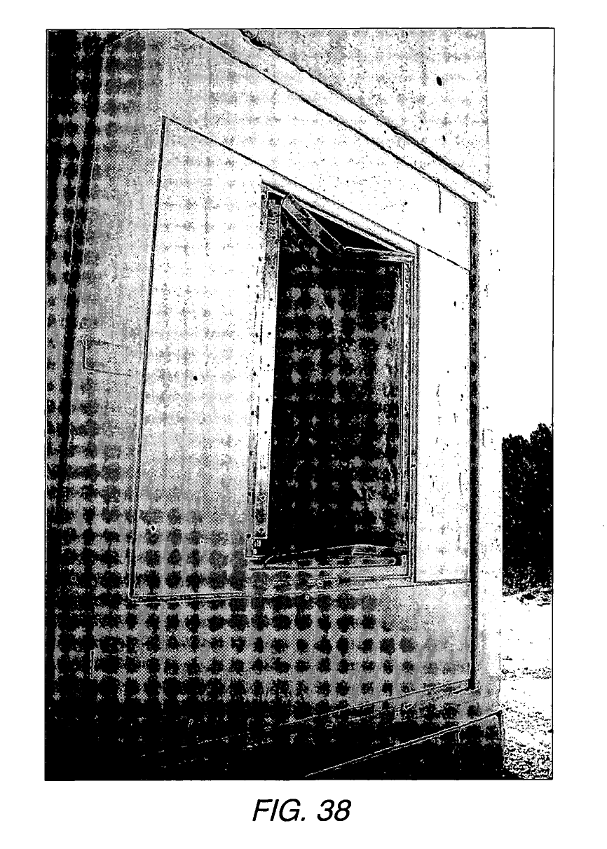

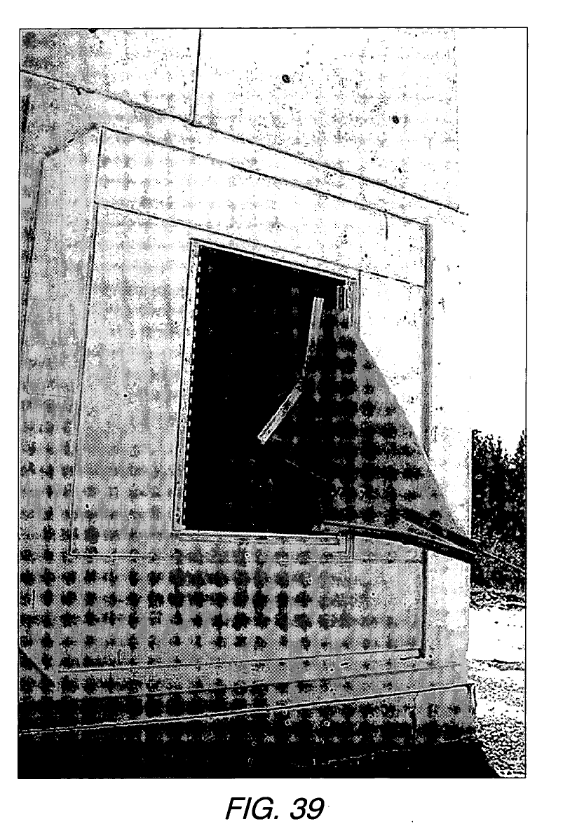

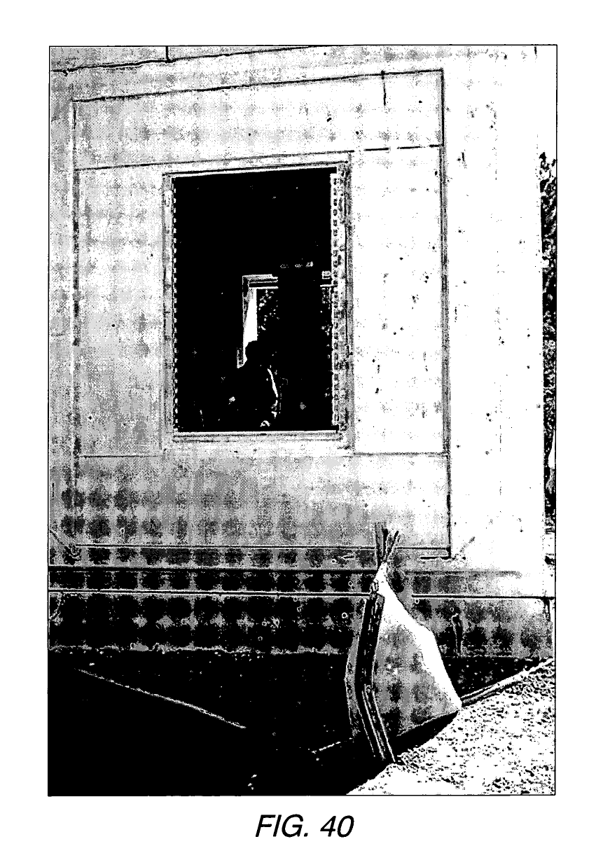

FIG. 38 shows a test building and window assembly following the bomb explosion. While the glass broke, the window stayed in place. FIG. 39 shows the same window being opened for use as an emergency escape following the explosion. As shown, the window assembly includes a hinge mounting system as described in FIGS. 11-16 which can be manually unlatched to remove the window. FIG. 40 shows the window fully removed from the building.

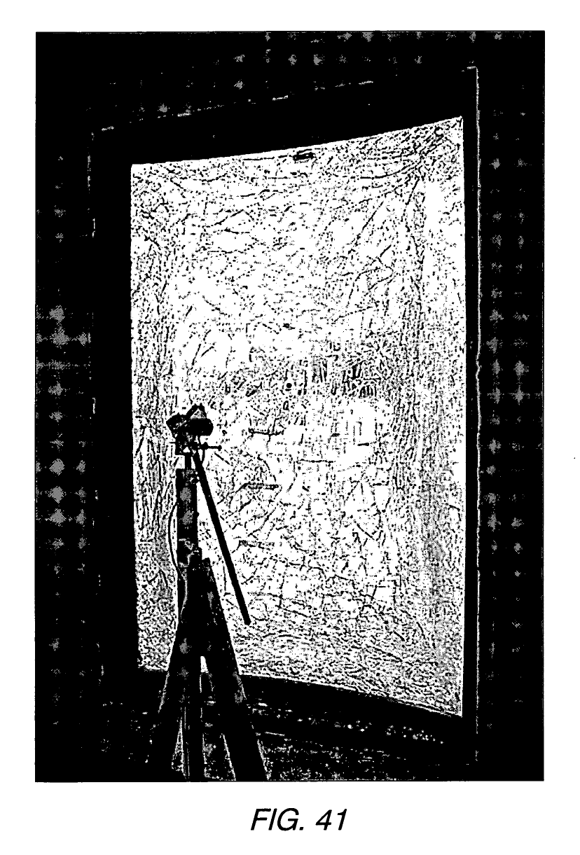

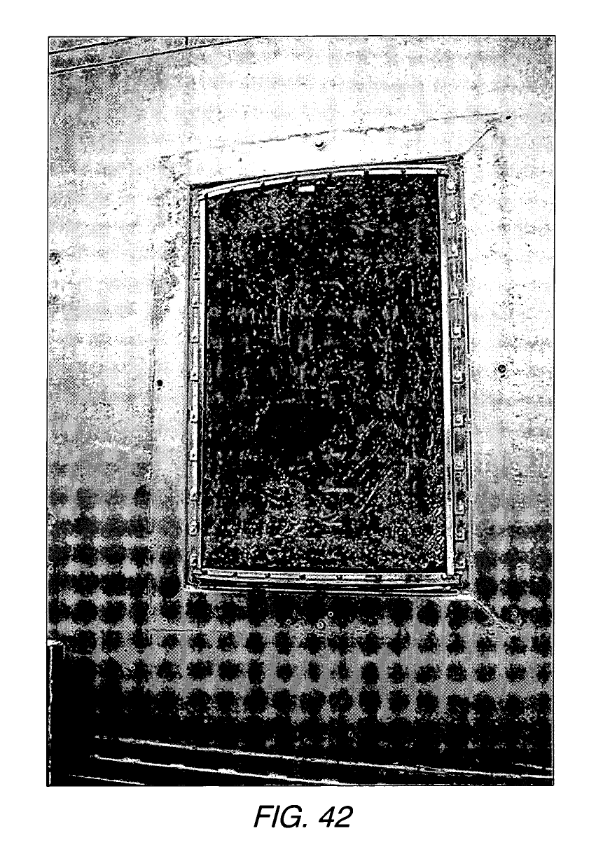

FIG. 41 shows an interior view of a test window made from curved laminated glass following an explosion. As shown, there was no pull-out of the curved glass from the frame system, indicating that bent or curved laminated glass can be used to withstand higher loads. FIG. 42 shows an exterior view of the same curved glass, which broke, but stayed in the frame.

The present invention provides several advantages. For example, laminating a mechanical anchorage component (i.e., an extension comprising an aluminum extrusion) along the perimeter for the PVB laminate window proved very efficient in allowing the laminate to reach maximum tension membrane capacity. The interface between the mechanical anchorage component and PVB proved to be more critical with thinner PVB laminates.

The higher resistance provided by bent or arched glazing was indicated by the resulting glass shard size and pattern, as well as reduced deflection and lower glazing velocity. This additional resistance allowed the glazing to dissipate more energy before and during the transition to a tension membrane using the blast resistant assembly.

During the blast, the assembly held into the aluminum extrusion and flexed to let the laminate stretch and absorb shock. The blast resistant assembly was successful at holding the window in place regardless of whether two or four sides of the glass were tested.

The hinge mounting system after the blast opened on the latch side to let the window open to its full extent. When the piano hinging side was unlatched, the entire window fell out, leaving a full opening to exit or enter. The hinge system was not distorted following the blast, indicating that a new sash could be installed in place.

The blast resistant assembly was a success for both a fixed window and an operating window. In both cases, the assembly secured the laminate into the frame and allowed the PVB to expand taking on the shock of the blast.

A key factor in securing the assembly and allowing the laminate to expand during the blast was the bonding or riveting of the laminate into the holes of the retainer

Whereas particular embodiments of this invention have been described above for purposes of illustration, it will be evident to those skilled in the art that numerous variations of the details of the present invention may be made without departing from the invention.

What is claimed is:

1. A blast resistant assembly comprising:
a frame;
a composite panel having at least one glass sheet and at least one polymeric layer mounted in the frame; and
at least one retainer extending from the frame and at least partially embedded in the polymeric layer for securing the composite panel within the frame when a force is applied to the composite panel.

2. The blast resistant assembly of claim 1, wherein the composite panel comprises a plurality of the glass sheets, and the at least one polymeric layer is located between the glass sheets.

3. The blast resistant assembly of claim 1, wherein the at least one retainer comprises:
a base connected to the frame; and
an extension connected to the base, wherein the extension is at least partially embedded in the at least one polymeric layer.

4. The blast resistant assembly of claim 3, wherein the base is an integral part of the frame.

5. The blast resistant assembly of claim 3, wherein the base is a separate part installed in the frame.

6. The blast resistant assembly of claim 3, wherein the extension comprises two opposed faces and each of the opposed faces contacts the at least one polymeric layer.

7. The blast resistant assembly of claim 3, wherein the extension comprises two opposed faces and one of the opposed faces contacts the at least one polymeric layer.

8. The blast resistant assembly of claim 3, wherein the extension comprises surface features for securing the extension within the at least one polymeric layer when a force is applied to the composite panel.

9. The blast resistant assembly of claim 3, wherein the extension has a serrated surface.

10. The blast resistant assembly of claim 3, wherein the extension comprises a first portion extending from the base and a second portion extending from the first portion in a direction substantially perpendicular to the first portion.

11. The blast resistant assembly of claim 10, wherein the first portion and the second portion form an L shape.

12. The blast resistant assembly of claim 10, wherein the first portion and the second portion form a T shape.

13. The blast resistant assembly of claim 3, wherein the extension has at least one through hole.

14. The blast resistant assembly of claim 13, wherein the at least one polymeric layer at least partially fills the at least one through hole.

15. The blast resistant assembly of claim 3, wherein the base has a generally rectangular cross-section.

16. The blast resistant assembly of claim 3, wherein the base has a generally square cross-section.

17. The blast resistant assembly of claim 3, wherein the base has a generally round cross-section.

18. The blast resistant assembly of claim 3, wherein the base comprises a longitudinal hole extending along a length of the base.

19. The blast resistant assembly of claim 3, further comprising:
at least one longitudinal channel extending along a length of the base; and
at least one projection on the frame engaging the at least one longitudinal channel.

20. The blast resistant assembly of claim 1, wherein the at least one retainer is slidably mounted to the frame.

21. The blast resistant assembly of claim 1, wherein the at least one retainer is pivotally mounted to the frame.

22. The blast resistant assembly of claim 1, wherein the at least one retainer is slidably and pivotally mounted to the frame.

23. The blast resistant assembly of claim 1, wherein the composite panel is formed by applying heat and pressure to the at least one glass sheet and the at least one polymeric layer.

24. The blast resistant assembly of claim 1, wherein the at least one polymeric layer is formed by injecting and curing a liquid polymer.

25. The blast resistant assembly of claim 1, wherein the composite panel is formed by at least partially bonding the at least one retainer between two of the polymeric layers, which are bonded between two glass sheets.

26. The blast resistant assembly of claim 25, wherein each of the polymeric layers contains a notch and the at least one retainer is at least partially bonded within the notches.

27. The blast resistant assembly of claim 1, wherein the assembly comprises three of the polymeric layers, and the at least one retainer is located in a plane defined by one of the polymeric layers which is positioned between the other polymeric layers.

28. The blast resistant assembly of claim 1, wherein the at least one retainer continuously surrounds the composite panel.

29. The blast resistant assembly of claim 1, wherein the at least one retainer discontinuously surrounds the composite panel.

30. The blast resistant assembly of claim 1, wherein the composite panel comprises a flat surface.

31. The blast resistant assembly of claim 1, wherein the composite panel comprises a curved surface.

32. A retainer for securing a composite panel comprising a glass sheet and a polymeric layer within a frame when a force is applied to the composite panel, the retainer comprising:
a base structured and arranged for mounting in the frame; and
an extension extending from the base and structured and arranged for securing to the polymeric layer.

33. The retainer of claim 32, wherein the extension comprises surface features for securing the extension within the polymeric layer when a force is applied to the composite panel.

34. The retainer of claim 32, wherein the extension has substantially planar opposing faces.

35. The retainer of claim 32, wherein the extension has a serrated surface.

36. The retainer of claim 32, wherein the extension comprises a first portion extending from the base and a second portion extending from the first portion in a direction substantially perpendicular to the first portion.

37. The retainer of claim 36, wherein the first portion and the second portion form an L shape.

38. The retainer of claim 36, wherein the first portion and the second portion form a T shape.

39. The retainer of claim 32, wherein the extension has at least one through hole.

40. The retainer of claim 32, wherein the base has a generally rectangular cross-section.

41. The retainer of claim 32, wherein the base has a generally square cross-section.

42. The retainer of claim 32, wherein the base has a generally round cross-section.

43. The retainer of claim 32, wherein the base comprises a longitudinal hole extending along a length of the base.

44. The retainer of claim 32, further comprising:
at least one longitudinal channel extending along a length of the base structured and arranged for engagement with at least one projection on the frame.

45. The retainer of claim 32, wherein the retainer is structured and arranged to be slidably mounted to the frame.

46. The retainer of claim 32, wherein the retainer is structured and arranged to be pivotally mounted to the frame.

47. The retainer of claim 32, wherein the retainer is structured and arranged to be slidably and pivotally mounted to the frame.

48. A blast resistant assembly comprising:
an outer frame;
an inner frame pivotally connected to the outer frame; and
a composite panel having at least one glass sheet and at least one polymeric layer, wherein the composite panel is mounted in the inner frame.

49. The blast resistant assembly of claim 48, further comprising at least one retainer for securing the composite panel within the inner frame when a force is applied to the composite panel.

50. The blast resistant assembly of claim 48, wherein the inner frame is pivotal between an open position and a closed position in relation to the outer frame.

51. The blast resistant assembly of claim 48, wherein the inner frame is removable from the outer frame.

52. The blast resistant assembly of claim 48, further comprising:
at least one hinge member positioned on the inner frame, wherein the at least one hinge member has a longitudinal hole;
at least one pin mounted within the longitudinal hole of the at least one hinge member, wherein the at least one pin is movable from a retracted position substantially inside the hinge member to an extended position substantially outside the hinge member; and
at least one hinge projection positioned on the outer frame and axially aligned with the at least one hinge member positioned on the inner frame, wherein the at least one hinge projection has a longitudinal hole for receiving the at least one pin when the pin is in the extended position.

53. The blast resistant assembly of claim 52, wherein the inner frame further comprises a slidable bar for mounting the at least one pin.

54. The blast resistant assembly of claim 53, wherein at least one handle is mounted to the slidable bar for moving the at least one pin from the retracted position to the extended position.

55. The blast resistant assembly of claim 48, wherein the composite panel comprises a flat surface.

56. The blast resistant assembly of claim 48, wherein the composite panel comprises a curved surface.

57. A blast resistant assembly comprising:
an outer frame;
an inner frame pivotally connected to the outer frame;
a composite panel having at least one glass sheet and at least one polymeric layer, wherein the composite panel is mounted in the inner frame; and
at least one retainer for securing the composite panel within the inner frame when a force is applied to the composite panel, wherein the at least one retainer comprises a base connected to the inner frame and an extension connected to the base and at least partially embedded in the at least one polymeric layer.

58. The blast resistant assembly of claim 57, wherein the extension comprises surface features for securing the extension within the at least one polymeric layer when a force is applied to the composite panel.

59. The blast resistant assembly of claim 57, wherein the extension has a serrated surface.

60. The blast resistant assembly of claim 57, wherein the extension comprises a first portion extending from the base and a second portion extending from the first portion in a direction substantially perpendicular to the first portion.

61. The blast resistant assembly of claim 60, wherein the first portion and the second portion form an L shape.

62. The blast resistant assembly of claim 60, wherein the first portion and the second portion form a T shape.

63. The blast resistant assembly of claim 57, wherein the extension has at least one through hole.

64. The blast resistant assembly of claim 57, wherein the base has a generally rectangular cross-section.

65. The blast resistant assembly of claim 57, wherein the base has a generally square cross-section.

66. The blast resistant assembly of claim 57, wherein the base has a generally round cross-section.

67. The blast resistant assembly of claim 57, wherein the base is slidably mounted to the inner frame.

68. The blast resistant assembly of claim 57, wherein the base is pivotally mounted to the inner frame.

69. The blast resistant assembly of claim 57, wherein the base is slidably and pivotally mounted to the inner frame.

70. The blast resistant assembly of claim 57, wherein the inner frame is pivotal between an open position and a closed position in relation to the outer frame.

71. The blast resistant assembly of claim 57, wherein the inner frame is removable from the outer frame.

72. The blast resistant assembly of claim 57, further comprising:
at least one hinge member positioned on the inner frame, wherein the at least one hinge member has a longitudinal hole;
at least one pin mounted within the longitudinal hole of the at least one hinge member, wherein the at least one pin is movable from a retracted position substantially inside the hinge member to an extended position substantially outside the hinge member; and
at least one hinge projection positioned on the outer frame and axially aligned with the at least one hinge member positioned on the inner frame, wherein the at least one hinge projection has a longitudinal hole for receiving the at least one pin when the pin is in the extended position.

73. The blast resistant assembly of claim 72, wherein the inner frame further comprises a slidable bar for mounting the at least one pin.

74. The blast resistant assembly of claim 73, wherein at least one handle is mounted to the slidable bar for moving the at least one pin from the retracted position to the extended position.
